(19) United States
(12) Patent Application Publication
(10) Pub. No.: US 2025/0218664 A1
(43) Pub. Date: Jul. 3, 2025

(54) MULTILAYERED CAPACITOR

(71) Applicant: SAMSUNG ELECTRO-MECHANICS CO., LTD., Suwon-si (KR)

(72) Inventors: Youngkyu Park, Suwon-si (KR); Hyunwoong Na, Suwon-si (KR); Kyoungki Min, Suwon-si (KR); Seongmin Park, Suwon-si (KR); Seula Park, Suwon-si (KR); Youngjoon Oh, Suwon-si (KR)

(73) Assignee: SAMSUNG ELECTRO-MECHANICS CO., LTD., Suwon-si (KR)

(21) Appl. No.: 18/912,000

(22) Filed: Oct. 10, 2024

(30) Foreign Application Priority Data
Dec. 27, 2023 (KR) 10-2023-0192911

(51) Int. Cl. H01G 4/008; H01G 4/12; H01G 4/30

(52) U.S. Cl. CPC H01G 4/0085; H01G 4/1227; H01G 4/30

(57) ABSTRACT

A multilayered capacitor according to an embodiment includes a capacitor body including a dielectric layer including a barium titanate-based compound as a main component; and an internal electrode including a conductive metal, and an external electrode outside the capacitor body,
wherein the internal electrode, an interface between the dielectric layer and the internal electrode, or all of them includes a co-material represented by Chemical Formula 1.

### CROSS-REFERENCE TO RELATED APPLICATION

This application claims priority to and the benefit of Korean Patent Application No. 10-2023-0192911 filed in the Korean Intellectual Property Office on Dec. 27, 2023, the entire contents of which are incorporated herein by reference.

### BACKGROUND

The present disclosure relates to a multilayered capacitor.

Recently, as multi-functionalization and miniaturization of electronic devices have been rapidly progressing, miniaturization and performance improvement of electronic components have also been progressing at a rapid pace. Further, the demand for high reliability of electric devices for use in automobiles, network equipment, or the like and electronic components for use in industries has also been increasing significantly.

In order to meet such market demands, competition for technology development of passive components such as inductors, capacitors, or resistors has been accelerating. In particular, great effort has been required to dominate the market by developing various multilayer ceramic capacitor (MLCC) products whose applications and usage as passive components have been continuously increasing.

In addition, a multilayered capacitor is manufactured by stacking dielectric layers and internal electrodes, and is used in various electronic devices such as mobile phones, laptops, and LCD TVs.

With recent technological advancements, multilayered capacitors are required to be miniaturized and have high capacities. To this end, technologies have been developed to increase an effective electrode area by increasing the connectivity of the internal electrodes in contact with the dielectric layer, or to atomize the dielectric material and internal electrode material.

Currently, in order to reduce a heat shrinkage temperature difference between the dielectric layer and the internal electrodes, when the internal electrodes are manufactured, a method of adding a nano-sized barium titanite (BaTiO₃) co-material is being used.

However, if a content of the barium titanite co-material is increased, which decreases layer density of the internal electrodes, because the co-material, which is diffused into the dielectric layer during the sintering, may increase a thickness of the dielectric layer, there may be a problem of causing a side effect of reducing capacitance of the capacitors.

### SUMMARY

One aspect of the embodiment provides a multilayered capacitor with excellent electrode connectivity and increased capacitance.

However, the problems that the embodiments seek to solve are not limited to the above-described problems and can be expanded in various ways within the scope of the technical ideas included in the embodiments.

A multilayered capacitor according to some embodiments of the present disclosure includes a capacitor body including a dielectric layer including a barium titanate-based compound as a main component; and an internal electrode including a conductive metal; and
an external electrode disposed on an outside surface the capacitor body,
wherein the internal electrode, an interface between the dielectric layer and the internal electrode, or all of them includes a co-material represented by Chemical Formula 1.

Mₙ₊₁AXₙ [Chemical Formula 1]

In Chemical Formula 1,
M includes at least one selected from the group consisting of Ti, Zr, Hf, Sc, Cr, V, Nb, Ta, Mo, Mn, and combinations thereof,
A includes at least one selected from the group consisting of a Group 11 element to a Group 16 element,
X includes C, N, or combinations thereof, and
n is an integer of 1 to 4.

The co-material may include at least one selected from the group consisting of Ti₂AlC, V₂AlC, Cr₂AlC, Nb₂AlC, Ta₂AlC, Zr₂AlC, Ti₂AlN, Ti₃AlC₂, V₃AlC₂, Ta₃AlC₂, Zr₃AlC₂, Ti₄AlN₃, V₄AlC₃, Nb₄AlC₃, Ta₄AlC₃, (Mo,V)₄AlC₃, Mo₄VAlC₄, Ti₃SiC₂, Ti₄SiC₃, Ti₂CdC, Sc₂InC, Sc₂SnC, Ti₂GaC, Ti₂InC, Ti₂TlC, V₂GaC, Cr₂GaC, Ti₂GaN, Ti₂InN, V₂GaN, Cr₂GaN, Ti₂GeC, Ti₂SnC, Ti₂PbC, V₂GeC, Cr₂GeC, V₂PC, V₂AsC, Ti₂SC, Zr₂InC, Zr₂TlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂GaC, Hf₂SnC, Hf₂PbC, Hf₂SnN, Hf₂SC, Ti₂ZnC, Ti₂ZnN, V₂ZnC, Nb₂CuC, Mn₂GaC, Mo₂AuC, Ti₂AuN, Ti₃GaC₂, Ti₃InC₂, Ti₃GeC₂, Ti₃SnC₂, Ti₃ZnC₂, Ti₄GaC₃, Ti₄GeC₃, and combinations thereof.

The barium titanate-based compound may include at least one selected from the group consisting of BaₘTiO₃ (0.995≤m≤1.010), (Ba_{1-X}Caₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba_{1-X}Caₓ)ₘ(Ti_{1-y}Sn_{y})O₃ (0.995≤m≤1.010, 0≤x≤0.10, 0<y≤0.20), and combinations thereof.

The dielectric layer may further include a subcomponent, and
the subcomponent may include at least one selected from the group consisting of dysprosium (Dy), vanadium (V), manganese (Mn), chromium (Cr), silicon (Si), aluminum (Al), magnesium (Mg), tin (Sn), antimony (Sb), and germanium. (Ge), gallium (Ga), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), indium (In), and combinations thereof.

The dielectric layer may further include the co-material.

The conductive metal may include at least one selected from the group consisting of Ni, Cu, Ag, Pd, Au, an alloy thereof, and combinations thereof.

A cross-sectional area occupied by the co-material may be about 0.1% to about 30% of a cross-sectional area of the internal electrode.

A multilayered capacitor according to another embodiments includes a capacitor body including a dielectric layer including a barium titanate-based compound as a main component; and an internal electrode including a conductive metal, and
an external electrode disposed on an outside surface of the capacitor body,
wherein the internal electrode, the dielectric layer, an interface between the dielectric layer and the internal electrode, or all of them includes a co-material represented by Chemical Formula 1.

Mₙ₊₁AXₙ [Chemical Formula 1]

In Chemical Formula 1,
M includes at least one selected from the group consisting of Ti, Zr, Hf, Sc, Cr, V, Nb, Ta, Mo, Mn, and combinations thereof,
A includes at least one selected from a Group 11 element to a Group 16 element,
X includes C, N, or a combination thereof, and
n is an integer of 1 to 4.

The co-material may include at least one selected from the group consisting of Ti₂AlC, V₂AlC, Cr₂AlC, Nb₂AlC, Ta₂AlC, Zr₂AlC, Ti₂AlN, Ti₃AlC₂, V₃AlC₂, Ta₃AlC₂, Zr₃AlC₂, Ti₄AlN₃, V₄AlC₃, Nb₄AlC₃, Ta₄AlC₃, (Mo,V)₄AlC₃, Mo₄VAlC₄, Ti₃SiC₂, Ti₄SiC₃, Ti₂CdC, Sc₂InC, Sc₂SnC, Ti₂GaC, Ti₂InC, Ti₂TlC, V₂GaC, Cr₂GaC, Ti₂GaN, Ti₂InN, V₂GaN, Cr₂GaN, Ti₂GeC, Ti₂SnC, Ti₂PbC, V₂GeC, Cr₂GeC, V₂PC, V₂AsC, Ti₂SC, Zr₂InC, Zr₂TlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂GaC, Hf₂SnC, Hf₂PbC, Hf₂SnN, Hf₂SC, Ti₂ZnC, Ti₂ZnN, V₂ZnC, Nb₂CuC, Mn₂GaC, Mo₂AuC, Ti₂AuN, Ti₃GaC₂, Ti₃InC₂, Ti₃GeC₂, Ti₃SnC₂, Ti₃ZnC₂, Ti₄GaC₃, Ti₄GeC₃, and combinations thereof.

The barium titanate-based compound may include at least one selected from the group consisting of BaₘTiO₃ (0.995≤m≤1.010), (Ba_{1-X}Caₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba_{1-X}Caₓ)ₘ(Ti_{1-y}Sn_{y})O₃ (0.995≤m≤1.010, 0≤x≤0.10, 0<y≤0.20), and combinations thereof.

The dielectric layer may further include a subcomponent, and
the subcomponent may include at least one selected from the group consisting of dysprosium (Dy), vanadium (V), manganese (Mn), chromium (Cr), silicon (Si), aluminum (Al), magnesium (Mg), tin (Sn), antimony (Sb), and germanium. (Ge), gallium (Ga), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), indium (In), and combinations thereof.

The conductive metal may include at least one selected from the group consisting of Ni, Cu, Ag, Pd, Au, an alloy thereof, and combinations thereof.

A cross-sectional area occupied by the co-material may be about 0.1% to about 30% of a cross-sectional area of the internal electrode.

The multilayered capacitor according to the embodiment has the advantage of excellent electrode connectivity and increased capacitance.

However, the various and beneficial advantages and effects of the present disclosure are not limited to the above-described descriptions, and may be more easily understood in the process of explaining specific embodiments of the present disclosure.

### BRIEF DESCRIPTION OF THE DRAWINGS

FIG. 1 is a perspective view showing a multilayered capacitor according to an embodiment.

FIG. 2 is a cross-sectional view of the multilayered capacitor taken along line I-I′ of FIG. 1.

FIG. 3 is an exploded perspective view showing the stacked structure of internal electrodes in the capacitor body of FIG. 1.

FIG. 4 is a schematic view showing a portion of the cross section of a multilayered capacitor according to an embodiment.

### DETAILED DESCRIPTION OF THE EMBODIMENTS

Hereinafter, exemplary embodiments of the present disclosure will be described in detail with reference to the accompanying drawings such that those skilled in the art can easily implement them. The drawings and description are to be regarded as illustrative in nature and not restrictive. Like reference numerals designate like elements throughout the specification. Further, the accompanying drawings are provided for helping to easily understand exemplary embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

When a constituent element is referred to as being “connected” or “coupled” to another constituent element, it will be appreciated that it may be directly connected or coupled to the other constituent element, or face the other constituent element, or intervening other constituent elements may be present. In contrast, when a constituent element is referred to as being “directly connected” or “directly coupled” to another constituent element, it will be appreciated that there are no intervening other constituent elements present.

In the present specification, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Accordingly, unless explicitly described to the contrary, the word “comprise,” and variations such as “comprises” or “comprising,” will be understood to imply the inclusion of stated elements but not the exclusion of any other elements.

In the present disclosure, “main component” means: an amount (content) of a barium titanate-based compound is 50 to 100 wt %, 60 to 100 wt %, 70 to 100 wt %, 80 to 100 wt %, 90 to 100 wt %, or substantially 100 wt % based on a total amount a dielectric layer.

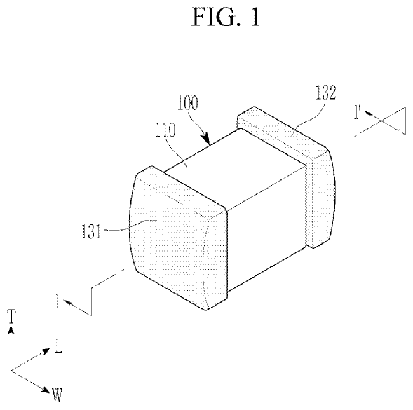

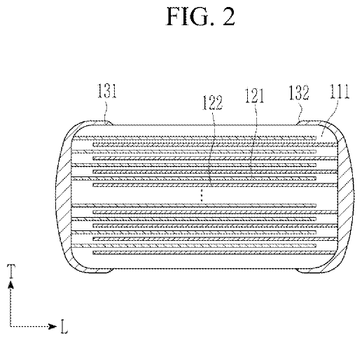

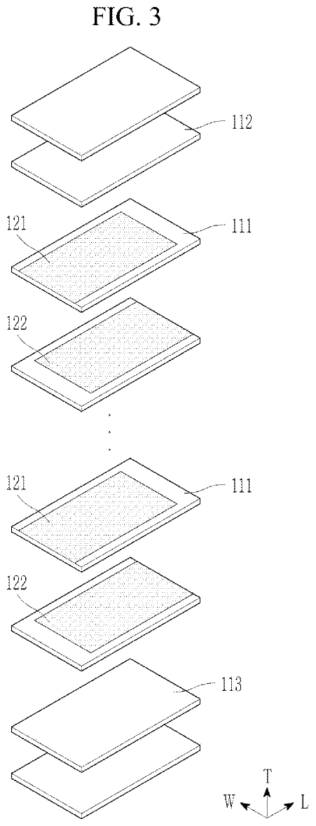

FIG. 1 is a perspective view showing a multilayered capacitor 100 according to an embodiment, FIG. 2 is a cross-sectional view of the multilayered capacitor 100 taken along line I-I′ of FIG. 1, and FIG. 3 is an exploded perspective view showing the stacked structure of internal electrodes in the capacitor body 110 of FIG. 1.

To clearly describe the present embodiment, directions are defined as follow: the L axis, the W axis, and the T axis shown in the drawings represent the longitudinal direction, width direction, and thickness direction of the capacitor body 110, respectively. Herein, the thickness direction (T-axis direction) may be a direction perpendicular to wide surfaces (main surfaces) of sheet-shaped constituent elements, and may be used, for example, as the same concept as the stacking direction in which dielectric layers 111 are stacked. The longitudinal direction (L-axis direction) may be a direction extending in parallel with the wide surfaces (main surfaces) of the sheet-shaped constituent elements and be a direction appropriately perpendicular to the thickness direction (T-axis direction), and may be, for example, a direction in which a first external electrode 131 and a second external electrode 132 are positioned on both sides. The width direction (W-axis direction) may be a direction extending in parallel with the wide surfaces (main surfaces) of the sheet-shaped constituent elements and be a direction appropriately perpendicular to the thickness direction (T-axis direction) and the longitudinal direction (L-axis direction), and the lengths of the sheet-shaped constituent elements in the longitudinal direction (L-axis direction) may be longer than their lengths in the width direction (W-axis direction).

Referring to FIGS. 1 to 3, the multilayered capacitor 100 according to the embodiment may include the capacitor body 110, and the first external electrode 131 and the second external electrode 132 that are disposed on both ends of the capacitor body 110 facing each other in the longitudinal direction (L-axis direction).

The capacitor body 110 may have, for example, an approximate hexahedral shape.

In the present embodiment, for ease of explanation, in the capacitor body 110, two surfaces facing each other in the thickness direction (T-axis direction) are defined as a first surface and a second surface, and two surfaces that are coupled to the first surface and the second surface and face each other in the longitudinal direction (L-axis direction) are defined as a third surface and a fourth surface, and two surfaces that are coupled to the first surface and the second surface, are coupled to the third surface and the fourth surface, and face each other in the width direction (W-axis direction) are defined as a fifth surface and a sixth surface.

As an example, the first surface which is the lower surface may be a surface oriented to the mounting direction. Further, the first surface to the sixth surface may be flat; however, the present exemplary embodiment is not limited thereto, and for example, the first surface to the sixth surface may be curved surfaces with convex center portions, and the border of each surface, i.e., the edge may be rounded.

The shape and dimensions of the capacitor body 110 and the number of dielectric layers 111 that are stacked are not limited to those shown in the drawings of the present embodiment.

The capacitor body 110 is formed by stacking a plurality of dielectric layers 111 in the thickness direction (T-axis direction) and sintering them, and includes the plurality of dielectric layers 111, and first internal electrodes 121 and second internal electrodes 122 that are alternately disposed in the thickness direction (T-axis direction) with the dielectric layers 111 interposed therebetween.

According to some embodiments, adjacent dielectric layers 111 in the capacitor body 110 may be so integrated such that it is difficult to see the boundaries between the dielectric layers without the use of a scanning electron microscope (SEM).

Further, the capacitor body 110 may include an active region and cover regions 112 and 113.

The active region is a portion that contributes to the formation of the capacitance of the multilayered capacitor 100. As an example, the active region may be the region where the first internal electrodes 121 and the second internal electrodes 122 that are stacked along the thickness direction (T-axis direction) overlap.

The cover regions 112 and 113 are margin portions in the thickness direction, and may be positioned on the first surface side and second surface side of the active region in the thickness direction (T-axis direction). These cover regions 112 and 113 may be stacked on the upper surface and lower surface of the active region, respectively, and each may consist of a single dielectric layer 111 or two or more dielectric layers 111.

Additionally, the capacitor body 110 may further include a side cover region. The side cover regions are margin portions in the width direction, and may be positioned on the fifth surface side and sixth surface side of the active region in the width direction (W-axis direction), respectively. These side cover regions may be formed by stacking dielectric green sheets with conductive paste layers for forming internal electrodes and sintering them. When the conductive paste layers are formed on the surfaces of the dielectric green sheets, the conductive paste may be coated only on some portions of the surfaces of the dielectric green sheets and may not be coated on both side surfaces of the surfaces of the dielectric green sheets.

The cover regions 112 and 113 and the side cover regions serve to prevent damage to the first internal electrodes 121 and the second internal electrodes 122 by physical or chemical stress.

A multilayered capacitor according to some embodiments of the present disclosure includes a capacitor body including a dielectric layer 111 including a barium titanate-based compound as a main component; and internal electrodes 121 and 122 including a conductive metal, and
an external electrode disposed on an outside surface of the capacitor body,
wherein the internal electrodes 121 and 122, an interface between the dielectric layer 111 and the internal electrodes 121 and 122, or all of them includes a co-material represented by Chemical Formula 1. According to some embodiments, the dielectric layer 111 may further include the co-material.

In some embodiments, the co-material is represented by Chemical Formula 1:

Mₙ₊₁AXₙ [Chemical Formula 1]

in Chemical Formula 1,
M includes at least one selected from the group consisting of Ti, Zr, Hf, Sc, Cr, V, Nb, Ta, Mo, Mn and combinations thereof,
A includes at least one selected from the group consisting of a Group 11 element to a Group 16 element,
X includes C, N, or a combination thereof, and
n is an integer of 1 to 4.

According to some embodiments, A may include any one or more selected from the group consisting of a Group 11 element to a Group 16 element. According to some embodiments, A may include a Group 13 element, a Group 14 element, and combinations thereof. As a specific example, the A may include at least one selected from the group consisting of Al, Ga, In, TI, Si, Ge, Sn, Pb, Zn, Cd, P, As, S, Cu, Au, and combinations thereof.

For example, the co-material may include at least one selected from the group consisting of Ti₂AlC, V₂AlC, Cr₂AlC, Nb₂AlC, Ta₂AlC, Zr₂AlC, Ti₂AlN, Ti₃AlC₂, V₃AlC₂, Ta₃AlC₂, Zr₃AlC₂, Ti₄AlN₃, V₄AlC₃, Nb₄AlC₃, Ta₄AlC₃, (Mo,V)₄AlC₃, Mo₄VAlC₄, Ti₃SiC₂, Ti₄SiC₃, Ti₂CdC, Sc₂InC, Sc₂SnC, Ti₂GaC, Ti₂InC, Ti₂TlC, V₂GaC, Cr₂GaC, Ti₂GaN, Ti₂InN, V₂GaN, Cr₂GaN, Ti₂GeC, Ti₂SnC, Ti₂PbC, V₂GeC, Cr₂GeC, V₂PC, V₂AsC, Ti₂SC, Zr₂InC, Zr₂TlC, Nb₂GaC, Nb₂InC, Mo₂GaC, Zr₂InN, Zr₂TIN, Zr₂SnC, Zr₂PbC, Nb₂SnC, Nb₂PC, Nb₂AsC, Zr₂SC, Nb₂SC, Hf₂InC, Hf₂TlC, Ta₂GaC, Hf₂SnC, Hf₂PbC, Hf₂SnN, Hf₂SC, Ti₂ZnC, Ti₂ZnN, V₂ZnC, Nb₂CuC, Mn₂GaC, Mo₂AuC, Ti₂AuN, Ti₃GaC₂, Ti₃InC₂, Ti₃GeC₂, Ti₃SnC₂, Ti₃ZnC₂, Ti₄GaC₃, Ti₄GeC₃, and combinations thereof.

As a specific example, the co-material may include at least one selected from the group consisting of Ti₂AlC, Ti₃AlC₂, Ti₃SiC₂, Ti₄SiC₃, Ti₂SnC, and combinations thereof.

The co-material may be a material added to delay a sintering speed of the conductive metal included in the internal electrodes 121 and 122 and to maintain a shrinkage start temperature similar to that of the dielectric material of the dielectric layer 111. The co-material may be included in the conductive paste for an internal electrode during the sintering of the capacitor body but after the sintering, included in the internal electrodes 121 and 122, the dielectric layer 111, an interface between the dielectric layer 111 and the internal electrodes 121 and 122, or all of them.

According to some embodiments, the co-material represented by Chemical Formula 1 may be a compound of MAX phases. The MAX phase compound is a compound having both metal and ceramic characteristics and exhibits very excellent thermal conductivity and electrical conductivity and also, high strength and modulus. The co-material represented by Chemical Formula 1 may be included in the internal electrodes 121 and 122, the dielectric layer 111, the interface layer, or all of them to obtain a multilayered capacitor with increased capacitance as well as excellent electrode connectivity.

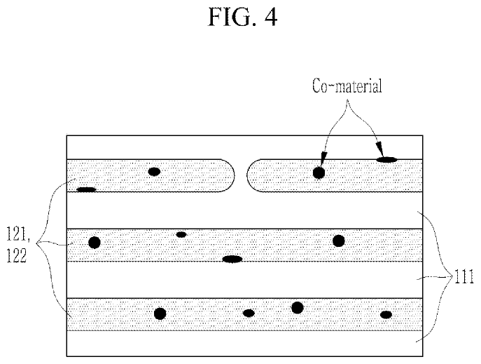

Referring to FIG. 4, the co-material represented by Chemical Formula 1 may be included in the internal electrodes 121 and 122 or on the interface between the internal electrodes 121 and 122 and the dielectric layer 111.

For example, a portion of the co-material included in the conductive paste for an internal electrode is trapped inside of the internal electrodes 121 and 122 during the sintering of the capacitor body to increases a sintering temperature of the internal electrodes 121 and 122 and thus improve strength of the internal electrodes, while delaying the sintering of the internal electrodes 121 and 122, thereby improving the connectivity of the internal electrodes 121 and 122. In addition, the co-material has excellent electrical conductivity and may serve as an electrode in the internal electrodes 121 and 122 and thus further improve the connectivity of the internal electrodes 121 and 122.

For example, another portion of the co-material included in the conductive paste for an internal electrode may be included in the interface between the dielectric layer 111 and the internal electrodes 121 and 122 during the sintering process of the capacitor body. The co-material included in the interface may promote the sintering to improve interface adherence between the internal electrodes 121 and 122 and the dielectric layer 111.

For example, still another portion of the co-material included in the conductive paste for an internal electrode may escape from the conductive paste for an internal electrode during the sintering process of the capacitor body and then, be diffused toward the dielectric green sheet and included in the dielectric layer 111. A conventional ceramic co-material, if diffused to the dielectric layer 111, has a problem of increasing a thickness of the dielectric layer 111 and thus decreasing capacitance of the capacitors. In contrast, the co-material represented by Chemical Formula 1 of the present disclosure, even if diffused to the dielectric layer 111, has excellent electrical conductivity and thus may solve the problem of increasing the thickness of the dielectric layer 111.

A method of checking the co-material represented by Chemical Formula 1 in the internal electrodes 121 and 122, the interface, or the dielectric layer 111 is as follows.

First, the multilayered capacitor 100 is placed in an epoxy mixture and cured, and the L-axis and T-axis direction sides of the capacitor body 110 are polished to ½ the point in a W-axis direction, then placed in a vacuum atmosphere chamber, and then, cut in the L-axis direction and the T-axis direction from the center of the W-axis direction of the capacitor body 110 to prepare a cross-sectional sample (hereinafter referred to as “cross-sectional sample”).

Subsequently, the cross-sectional sample is examined with a transmission electron microscope (TEM) or a scanning electron microscope (SEM) to prepare TEM or SEM images.

For example, the images are analyzed through TEM-EDS or SEM-EDS to obtain an element distribution in each region and set a region where a dielectric material (e.g., Ba) is not detected as a boundary, which is used to check the interface between the internal electrodes 121 and 122 and the dielectric layer 111. For another example, the images may be binarized, etc. to check the electrodes 121 and 122 and the dielectric layer 111, which have a contrast difference, as the interface therebetween.

Subsequently, the distribution of elements included in the co-material represented by Chemical Formula 1 may be analyzed to check the presence of the co-material in the internal electrodes 121 and 122, the interface, or the dielectric layer 111.

For example, the co-material may take a cross-section of about 0.1% to about 30% in the total cross-section of the internal electrodes 121 and 122.

The cross-section of the internal electrodes may refer to an area where the co-material is trapped in the internal electrodes.

If the area taken by the co-material is less than about 0.1% in the total cross-section of the internal electrodes 121 and 122, the electrode connectivity may be difficult to sufficiently improve. In addition, if the area taken by the co-material is greater than about 30% in the total cross-section of the internal electrodes 121 and 122, a short circuit may more occurs due to agglomeration phenomenon, deteriorating the electrode connectivity.

### Internal Electrode

The first internal electrodes 121 and the second internal electrodes 122 are electrodes with different polarities, respectively, and may be alternately arranged opposite each other along the T-axis direction with the dielectric layer 111 in between, and one end may be exposed through the third and fourth surfaces of the capacitor body 110, respectively.

The first internal electrodes 121 and the second internal electrodes 122 may be electrically insulated from each other by the dielectric layers 111 disposed therebetween.

The end portions of the first internal electrodes 121 and the second internal electrodes 122 that are alternately exposed from the third and fourth surfaces of the capacitor body 110 may be electrically coupled to the first external electrode 131 and the second external electrode 132, respectively.

In some embodiments, the internal electrodes 121 and 122 include a conductive metal and the aforementioned co-material represented by Chemical Formula 1.

Since the common material represented by Chemical Formula 1 has been described above, its description is omitted here.

According to some examples, the conductive metal may include at least one selected from the group consisting of Ni, Cu, Ag, Pd, Au, alloys thereof, and combinations thereof. For example, the conductive metal may include a metal such as Ni, Cu, Ag, Pd, or Au, or an alloy thereof, for example an Ag—Pd alloy.

Also, the first internal electrodes 121 and the second internal electrodes 122 may include dielectric particles of the same composition system as that of the ceramic material that is included in the dielectric layers 111.

The first internal electrodes 121 and the second internal electrodes 122 may be formed using conductive paste including a conductive metal. The printing method of the conductive paste may use a screen printing method, a gravure printing method, or the like.

According to some examples, the average thicknesses of the first internal electrodes 121 and the second internal electrodes 122 may be greater than or equal to about 0.05 μm, greater than or equal to about 0.1 μm, greater than or equal to about 0.2 μm, or greater than or equal to about 0.25 μm, and less than or equal to about 2 μm, less than or equal to about 1 μm, or less than or equal to about 0.5 μm.

The average thickness of the first internal electrode 121 or second internal electrode 122 may be measured by the following method.

It may be an arithmetic mean value of the thicknesses of the first internal electrode 121 or second internal electrode 122 at 10 points spaced at predetermined intervals from a reference point in the scanning electron microscope (SEM) of the cross-sectional sample, when the center point in the longitudinal direction (L-axis direction) or width direction (W-axis direction) of the first internal electrode 121 or second internal electrode 122 is used as a reference point.

The intervals between the 10 points may be adjusted according to the scale of the SEM image, and may be, for example, an interval of about 1 μm to about 100 μm, about 1 μm to about 50 μm, or about 1 μm to about 10 μm.

In this case, all 10 points should be located within the first internal electrode 121 or the second internal electrode layer 122, and when all 10 points are not located within the first internal electrode 121 or the second internal electrode layer 122, the position of the reference point may be changed or the interval of 10 points may be adjusted.

### Dielectric Laver

The dielectric layer 111 includes a dielectric material, and the dielectric material may include a main component and a subcomponent.

The main component is a dielectric base material, has a high dielectric constant, and contributes to forming the dielectric constant of the multilayered capacitor 100.

For example, the main component may include a barium titanate-based compound, and the barium titanate-based compound may include at least one selected from the group consisting of a dielectric material including BaₘTiO₃ (0.995≤m≤1.010), (Ba_{1-X}Caₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba_{1-X}Caₓ)ₘ(Ti_{1-y}Sn_{y})O₃ (0.995≤m≤1.010, 0≤x≤0.10, 0<y≤0.20), and combinations thereof.

For example, the main component may include at least one selected from the group consisting of BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, and combinations thereof.

For example, the subcomponent may include at least one selected from the group consisting of dysprosium (Dy), vanadium (V), manganese (Mn), chromium (Cr), silicon (Si), aluminum (Al), magnesium (Mg), tin (Sn), antimony (Sb), and germanium. (Ge), gallium (Ga), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), indium (In), and combinations thereof.

The dielectric material may further include at least one selected from the group consisting of a ceramic additive, an organic solvent, a binder, a dispersant, and combinations thereof.

According to some examples, the dielectric layer 111 may further include a co-material represented by Chemical Formula 1, and since it has been described above, detailed description will be omitted here.

For example, an average thickness of the dielectric layer 111 may be greater than or equal to about 0.3 μm, greater than or equal to about 0.5 μm, greater than or equal to about 1.0 μm, or greater than or equal to about 2.0 μm, and less than or equal to about 10 μm, less than or equal to about 8.0 μm, less than or equal to about 5.0 μm, or less than or equal to about 3.0 μm.

The average thickness of the dielectric layer 111 may be measured by the following method.

First, a scanning electron microscope (SEM) image obtained by observing a cross-sectional sample with a scanning electron microscope is prepared.

It may be an arithmetic mean value of the thicknesses of the dielectric layer 111 at 10 points spaced at predetermined intervals from a reference point in the SEM image of the cross-sectional sample, when the center point in the longitudinal direction (L-axis direction) or width direction (W-axis direction) of the dielectric layer 111 is used as a reference point.

The intervals between the 10 points may be adjusted according to the scale of the SEM image, and may be, for example, an interval of about 1 μm to about 100 μm, about 1 μm to about 50 μm, or about 1 μm to about 10 μm.

In this case, all 10 points should be located within the dielectric layers 111, and when all 10 points are not located within the dielectric layers 111, the position of the reference point may be changed or the interval of 10 points may be adjusted.

### External Electrode

The first external electrode 131 and the second external electrode 132 are provided with voltages with different polarity and respectively connected electrically to each exposed portion of the first internal electrode 121 and the second internal electrode 122.

According to the above configuration, if a predetermined voltage is applied to the first external electrode 131 and the second external electrode 132, charges are accumulated between the first internal electrode 121 and the second internal electrode 122 facing each other. Herein, the multilayered capacitor 100 may have proportional capacitance to an area where the first internal electrode 121 and the second internal electrode 122 are overlapped each other along a T-axis direction in the active region.

The first external electrode 131 and the second external electrode 132 may be disposed on the third and fourth surfaces of the capacitor body 110, respectively, and may include first and second connection portions, respectively, that are coupled to the first internal electrodes 121 and the second internal electrodes 122, respectively, and include first and second band portions, respectively, that are disposed at the edges where the third and fourth surfaces of the capacitor body 110 meet either the first and second surfaces or the fifth and sixth surfaces.

The first and second band portions may extend from the first and second connection portions to some points of either the first and second surfaces or fifth and sixth surfaces of the capacitor body 110. The first and second band portions may serve to improve the adhesion strength of the first external electrode 131 and the second external electrode 132.

According to some examples, each of the first external electrode 131 and the second external electrode 132 may include a sintered metal layer that is in contact with the capacitor body 110, a conductive resin layer that is disposed to cover the sintered metal layer, and a plating layer that is disposed to cover the conductive resin layer.

The sintered metal layer may include a conductive metal and glass.

According to some examples, the sintered metal layer may include, as the conductive metal, at least one selected from the group consisting of copper (Cu), nickel (Ni), silver (Ag), palladium (Pd), gold (Au), platinum (Pt), tin (Sn), tungsten (W), titanium (Ti), lead (Pb), an alloy thereof, and combinations thereof, and for example, copper (Cu) may include a copper (Cu) alloy. When the conductive metal includes copper, metals other than copper may be included in the amount of less than or equal to about 5 parts by mole based on 100 parts by mole of copper.

According to some examples, the sintered metal layer may include a composition including oxides as glass, and may include, for example, one or more selected from the group consisting of silicon oxides, boron oxides, aluminum oxides, transition metal oxides, alkali metal oxides, and alkaline earth metal oxides. The transition metal may be selected from the group consisting of zinc (Zn), titanium (Ti), copper (Cu), vanadium (V), manganese (Mn), iron (Fe), and nickel (Ni), and the alkali metal may be selected from the group consisting of lithium (U), sodium (Na), and potassium (K), and the alkaline earth metal may be one or more selected from the group consisting of magnesium (Mg), calcium (Ca), strontium (Sr), and barium (Ba).

Optionally, the conductive resin layer is formed on the sintered metal layer, and for example, may be formed to completely cover the sintered metal layer. Meanwhile, the first external electrode 131 and the second external electrode 132 may not include a sintered metal layer, and in this case, the conductive resin layer may be in direct contact with the capacitor body 110.

The conductive resin layers may extend to the first and second surfaces or fifth and sixth surfaces of the capacitor body 110, and the lengths of regions (i.e., band portions) where the conductive resin layers extend to the first and second surfaces or fifth and sixth surfaces of the capacitor body 110 may be longer than the lengths of regions (i.e., band portions) where the sintered metal layers extend in the first and second surfaces or fifth and sixth surfaces of the capacitor body 110. In other words, the conductive resin layers may be formed on the sintered metal layers, and may be formed so as to completely cover the sintered metal layers.

The conductive resin layers include a resin and a conductive metal.

The resin included in the conductive resin layers is not particularly limited as long as it has a bonding property and an impact absorption property and can be mixed with conductive metal powder to form a paste, and may include, for example, a phenolic resin, an acrylic resin, a silicone resin, an epoxy resin, or a polyimide resin.

The conductive metal included in the conductive resin layers serves to electrically connect the conductive resin layers to the first internal electrode 121 and the second internal electrode 122, or the sintered metal layer.

The conductive metal included in the conductive resin layer may have a spherical shape, a flake shape, or a combination thereof. In other words, the conductive metal may be formed only in a flake shape, or may be formed only in a spherical shape, or may be the form of a mixture of a flake shape and a spherical shape.

Herein, the spherical shape may include a shape which is not completely spherical, and may include, for example, a shape in which a ratio of the length of the major axis to the length of the minor axis (major axis/minor axis) may be less than or equal to about 1.45. The flake-type powder refers to a powder with a flat and elongated shape, and is not particularly limited, but for example, a ratio of the length of the major axis to the length of the minor axis (major axis/minor axis) may be greater than or equal to about 1.95.

The first external electrode 131 and the second external electrode 132 may further include a plating layer disposed on an outside surface of the conductive resin layer.

The plating layer may include at least one selected from the group consisting of nickel (Ni), copper (Cu), tin (Sn), palladium (Pd), platinum (Pt), gold (Au), silver (Ag), tungsten (W), titanium (Ti), lead (Pb), and alloys thereof. According to some examples, each plating layer may be a nickel (Ni) plating layer or a tin (Sn) plating layer, or may be a form in which a nickel (Ni) plating layer and a tin (Sn) plating layer are sequentially stacked, or may be a form in which a tin (Sn) plating layer, a nickel (Ni) plating layer, and a tin (Sn) plating layer are sequentially stacked. Alternatively, each plating layer may include a plurality of nickel (Ni) plating layers and/or a plurality of tin (Sn) plating layers.

The plating layer can improve mountability to the substrate, structural reliability, durability to the outside, heat resistance, and equivalent series resistance (ESR) of the multilayered capacitor 100.

### Method of Manufacturing Multilayered Capacitor

A method of manufacturing the multilayered capacitor according to another embodiment includes manufacturing a capacitor body including a dielectric layer and an internal electrode and then, forming an external electrode on the outside surface of the capacitor body.

First, a method of manufacturing the capacitor body according to some embodiments of the present disclosure is explained below.

In the manufacturing process of the capacitor body, a dielectric paste, which will be formed into a dielectric layer after sintering, and a conductive paste, which will be formed into an internal electrode after the sintering, are prepared.

The dielectric paste is, for example, prepared in the following method. Dielectric powders are uniformly mixed through wet mixing and the like, dried, and heat-treated under predetermined conditions obtain plasticized powder. Subsequently, an organic vehicle or an aqueous vehicle is added to the plasticized powder and additionally, kneaded to prepare the dielectric paste.

The obtained dielectric paste is formed into a dielectric green sheet by using a technique such as the doctor blade method. Additionally, the dielectric paste may include additives selected from various dispersants, plasticizers, dielectrics, subcomponent compounds, or glass, if necessary.

The conductive paste for internal electrodes is prepared by kneading a conductive powder made of a conductive metal or its alloy and a co-material represented by Chemical Formula 1 with a binder or a solvent.

Mₙ₊₁AXₙ [Chemical Formula 1]

In Chemical Formula 1,
M includes at least one selected from the group consisting of Ti, Zr, Hf, Sc, Cr, V, Nb, Ta, Mo, Mn, and combinations thereof,
A includes at least one selected from the group consisting of a Group 11 element to a Group 16 element,
X includes C, N, or a combination thereof, and
n is an integer of 1 to 4.

Since the co-material represented by Chemical Formula 1 has been described above, detailed description will be omitted here.

The conductive paste for an internal electrode is coated with a predetermined pattern on the dielectric green sheet surface in various printing methods such as screen printing or transfer methods, etc. Subsequently, the dielectric green sheets with the internal electrode pattern in plural are stacked and then, pressed in a stacking direction to obtain a dielectric green sheet laminate. Herein, the internal electrode patterns may be stacked so that the dielectric green sheet laminate may have a dielectric green sheet at the top and at the bottom in the stacking direction.

Optionally, the obtained dielectric green sheet laminate may be cut into a predetermined size by dicing or the like.

In addition, the dielectric green sheet laminate, if necessary, may be solidified and dried to remove the plasticizer and the like and then, barrel-polished by using a horizontal centrifugal barrel machine, etc. In the barrel-polishing, unnecessary parts such as burrs, etc., which are generated during the cutting, may be polished by inserting the dielectric green sheet laminate with media and a polishing solution into a barrel container and then, applying rotational motion, vibration, or the like to the barrel container. In addition, after the barrel-polishing, the dielectric green sheet laminate may be washed with a cleaning solution such as water and the like and dried.

The dielectric green sheet laminate is subjected to binder removal and sintering treatments to obtain a capacitor body.

The binder removal treatment is performed under conditions appropriately adjusted according to a main component composition of the dielectric layer and a main component composition of the internal electrode. For example, the binder removal treatment is performed by increasing a temperature at about 5° C./hour to about 300° C./hour and maintained at a support temperature of about 180° C. to about 400° C. for about 0.5 hour to about 24 hours. The binder removal is performed under an air or reducing atmosphere.

The sintering treatment may be performed under conditions appropriately adjusted according to a main component composition of the dielectric layer or a main component composition of the internal electrode. For example, the sintering treatment may be performed at about 1200° C. to about 1350° C. or about 1220° C. to about 1300° C. for about 0.5 hour to about 8 hours or about 1 hour to about 3 hours. The sintering treatment is performed under a reducing atmosphere, for example, under an atmosphere in which a mixed gas of nitrogen gas (N₂) and hydrogen gas (H₂) is humidified.

After the sintering treatment, annealing may be performed. Because the annealing is a treatment to reoxidize the dielectric layer, if the sintering is performed under the reducing atmosphere, the annealing may be performed. The annealing treatment is performed under conditions appropriately adjusted according to a main component composition of the dielectric layer and the like. For example, the annealing treatment may be performed at about 950° C. to about 1150° C. for about 0 hour to about 20 hours at about 50° C./hour to about 500° C./hour. In addition, the annealing may be performed under a humidified nitrogen gas (N₂) atmosphere at an oxygen partial pressure of about 1.0×10⁻⁹ MPa to about 1.0×10⁻⁵ MPa.

The humidifying nitrogen gas, mixed gas, or the like in the binder removal treatment, the sintering treatment, or the annealing treatment may be performed, for example, by using a wetter and the like, wherein a temperature of water used therein may be at about 5° C. to about 75° C. The binder removal treatment, the sintering treatment, and the annealing treatment may be performed sequentially or independently.

Optionally, the third and fourth surfaces of the capacitor body may be subjected to surface treatment such as sand blasting, laser irradiation, or barrel polishing. This surface treatment may expose ends of the first and second internal electrodes onto the outermost surfaces of the third and fourth surfaces, which may solidify electrical bonding between the first and second external electrodes and the first and second internal electrodes and easily forming alloy portions.

Subsequently, a paste for forming a sintered metal layer is coated on the outside surface of the obtained capacitor body and sintered to form sintered metal layers as the external electrodes.

The paste for forming a sintered metal layer may include a conductive metal and glass. The conductive metal and the glass are the same as aforementioned above and thus will not be repetitively mentioned. In addition, the paste for forming a sintered metal layer may optionally include a subcomponent such as a binder, solvent, dispersant, plasticizer, or oxide powder. For example, the binder may be ethylcellulose, acrylic, or butyral, and the solvent may be an organic solvent such as terpineol, butyl carbitol, alcohol, methyl ethyl ketone, acetone, or toluene, or an aqueous solvent.

A method of coating the paste for forming a sintered metal layer on the outside surface of the capacitor body may include various printings such as dipping, or screen printing and the like, coating by using a dispenser, etc., spraying using a spray, and the like. The paste for forming a sintered metal layer is coated at least on the third and fourth surfaces of the capacitor body and optionally, each portion of the first surface, the second surface, the fifth surface, or the sixth surface where band portions of the first and second external electrodes are formed.

Subsequently, the capacitor body, which is coated with the paste for forming a sintered metal layer, is dried and sintered at about 700° C. to about 1000° C. for about 0.1 hour to about 3 hours to form the sintered metal layers.

Optionally, on the outside surface of the obtained capacitor body, a paste for forming a conductive resin layer is coated and cured to form a conductive resin layer.

The paste for forming the conductive resin layer may include a resin and, optionally, a conductive metal or a non-conductive filler. Because the descriptions of the conductive metal and resin are the same as described above, repetitive description will be omitted. Additionally, the paste for forming the conductive resin layer may optionally include a subcomponent such as a binder, solvent, dispersant, plasticizer, or oxide powder. For example, the binder may include ethylcellulose, acrylic, or butyral, and the solvent may include an organic solvent such as terpineol, butyl carbitol, alcohol, methyl ethyl ketone, acetone, or toluene, or an aqueous solvent.

For example, a method of forming the conductive resin layer may include dipping the capacitor body 110 in the paste for forming a conductive resin layer and curing it, or printing the paste for forming a conductive resin layer on the surface of the capacitor body 110 in screen printing, gravure printing, etc. or coating and coating the paste for forming a conductive resin layer on the surface of the capacitor body 110 and then, curing it.

Subsequently, the plating layer is formed on the outside surface of the conductive resin layer.

For example, the plating layer may be formed in a plating method, for example, by sputtering or electric deposition.

Hereinafter, specific examples of the disclosure will be presented. However, the following examples are intended only to specifically illustrate or describe the disclosure, and should not be construed as limiting the scope of the disclosure.

### EXAMPLES

### Example 1

A dielectric green sheet was prepared by preparing dielectric slurry including BaTiO₃ and then, coating the dielectric slurry with a head discharge-type on-roll coater.

Next, a conductive paste for internal electrodes was prepared using conductive powder including Ni and a Ti₃AlC₂ co-material.

The conductive paste was printed on the surface of the dielectric green sheet, and the dielectric green sheets (width×length×height=3.2 mm×2.5 mm×2.5 mm) with the conductive paste layer are in plural stacked and compressed to manufacture a dielectric green sheet laminate.

The dielectric green sheet laminate was plasticized at 400° C. or less under a nitrogen atmosphere and sintered at 1300° C. or less at a hydrogen (H₂) concentration of 1.0% or less to manufacture a multilayered capacitor according to Example 1.

### Example 2

A multilayered capacitor according to Example 2 was manufactured in the same manner as in Example 1 except that the conductive paste for an internal electrode was prepared to include Ti₂AlC instead of Ti₃AlC₂ as a co-material.

### Example 3

A multilayered capacitor according to Example 3 was manufactured in the same manner as in Example 1 except that the conductive paste for an internal electrode was prepared to include Ti₃SiC₂ instead of Ti₃AlC₂ as a co-material.

### Example 4

A multilayered capacitor according to Example 4 was manufactured in the same manner as in Example 1 except that the conductive paste for an internal electrode was prepared to include Ti₂SnC instead of Ti₃AlC₂ as a co-material.

### Comparative Example 1

A multilayered capacitor according to Comparative Example 1 was manufactured in the same manner as in Example 1 except that the conductive paste for an internal electrode was prepared to include BaTiO₃ instead of Ti₃AlC₂ as a co-material.

### Evaluation Examples

### Evaluation Example 1: Evaluation of Electrode Connectivity

The multilayered capacitors according to Examples 1 to 4 and Comparative Example 1 were evaluated with respect to electrode connectivity.

First, the multilayered capacitor was placed in an epoxy mixture and cured, and the W-axis and T-axis direction sides of the capacitor body 110 were polished to ½ the point in a L-axis direction, then placed in a vacuum atmosphere chamber, and then, cut in the W-axis direction and the T-axis direction from the center of the L-axis direction of the capacitor body to prepare a cross-sectional sample (hereinafter referred to as “cross-sectional sample”). Subsequently, the cross-sectional samples were examined with a scanning electron microscope (SEM) to prepare SEM images.

Subsequently, after selecting any internal electrode and drawing an imaginary line thereon in the L-axis direction to measure a ratio of an unbroken length of the internal electrode to a total length of the internal electrode, the results are shown in Table 1.

### Evaluation Example 2: Capacitance Evaluation

The multilayered capacitors of Examples 1 to 4 and Comparative Example 1 were evaluated with respect to capacitance.

Specifically, capacitance of each capacitor sample was measured by using a LCR meter and then, divided by a sample volume of 2.88 mm³ to obtain capacitance per unit volume. After setting a rated voltage of each sample at 50 V, the obtained capacitance per unit volume unit volume was multiplied by the rated voltage to derive capacitance of each multilayered capacitor.

After setting capacitance of the multilayered capacitor of Comparative Example 1 as a reference (100%), capacitance of the multilayered capacitors of Examples 1 to 4 was converted as a relative ratio, and the results are shown in Table 1.

### Evaluation Example 3: Evaluation of Moisture-Resistance Reliability

The multilayered capacitors of Examples 1 to 4 and Comparative Example 1 were evaluated with respect to moisture-resistance reliability.

The moisture-resistance reliability was evaluated by conducting an 8585 test, which was performed at 85° C. under relative humidity of 85% at a rated voltage of 1 Vr for 24 hours.

Herein, if any one of the multilayered capacitors has a ratio of insulation resistance (IR) of 106 or less to initial insulation resistance (IR), it was evaluated as defective and marked as “X” in Table 1.

In addition, if the ratio of the initial insulation resistance (IR₀) to the insulation resistance (IR) falls to 10⁶ or less, it was evaluated as not defective and marked as “◯” in the following table.

TABLE 1

| | | | | Moisture- |
|---|---|---|---|---|
| | | Electrode | | resistance |
| | Co-material | connectivity | Capacitance | reliability |
| Example 1 | Ti₃AlC₂ | 90.4% | 118% | ∘ |
| Example 2 | Ti₂AlC | 90.1% | 113% | ∘ |
| Example 3 | Ti₃SiC₂ | 89.5% | 114% | ∘ |
| Example 4 | Ti₂SnC | 91.8% | 109% | ∘ |
| Comparative | BaTiO₃ | 89.7% | 100% | ∘ |
| Example 1 | | | (reference) | |

Referring to Table 1, the multilayered capacitors of Examples 1 to 4 using a MAX phase compound as a co-material exhibited equivalently excellent electrode connectivity and moisture-resistance reliability to that of Comparative Example 1 and also, significantly excellent capacitance.

While this disclosure has been described in connection with what is presently considered to be practical exemplary embodiments, it is to be understood that the disclosure is not limited to the disclosed exemplary embodiments. On the contrary, it is intended to cover various modifications and equivalent arrangements included within the spirit and scope of the appended claims.

### DESCRIPTION OF SYMBOLS

100: multilayered capacitor
110: capacitor body
111: dielectric layer
112, 113: cover region
121: first internal electrode
122: second internal electrode
131: first external electrode
132: second external electrode

What is claimed is:

1. A multilayered capacitor, comprising
a capacitor body including a dielectric layer including a barium titanate-based compound as a main component; and an internal electrode including a conductive metal, and
an external electrode disposed on an outside surface of the capacitor body,
wherein at least one of the internal electrode or an interface between the dielectric layer and the internal electrode includes a co-material represented by Chemical Formula 1:
Mₙ₊₁AXₙ [Chemical Formula 1]
wherein, in Chemical Formula 1,
M includes at least one selected from the group consisting of Ti, Zr, Hf, Sc, Cr, V, Nb, Ta, Mo, Mn, and combinations thereof,
A includes at least one selected from the group consisting of a Group 11 element to a Group 16 element,
X includes C, N, or a combination thereof, and
n is an integer from 1 to 4.

2. The multilayered capacitor of claim 1, wherein
the co-material includes at least one selected from the group consisting of Ti₂AlC, V₂AlC, Cr₂AlC, Nb₂AlC, Ta₂AlC, Zr₂AlC, Ti₂AlN, Ti₃AlC₂, V₃AlC₂, Ta₃AlC₂, Zr₃AlC₂, Ti₄AlN₃, V₄AlC₃, Nb₄AlC₃, Ta₄AlC₃, (Mo,V)₄AlC₃, Mo₄VAlC₄, Ti₃SiC₂, Ti₄SiC₃, Ti₂CdC, Sc₂InC, Sc₂SnC, Ti₂GaC, Ti₂InC, Ti₂TlC, V₂GaC, Cr₂GaC, Ti₂GaN, Ti₂InN, V₂GaN, Cr₂GaN, Ti₂GeC, Ti₂SnC, Ti₂PbC, V₂GeC, Cr₂GeC, V₂PC, V₂AsC, Ti₂SC, Zr₂InC, Zr₂TlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂GaC, Hf₂SnC, Hf₂PbC, Hf₂SnN, Hf₂SC, Ti₂ZnC, Ti₂ZnN, V₂ZnC, Nb₂CuC, Mn₂GaC, Mo₂AuC, Ti₂AuN, Ti₃GaC₂, Ti₃InC₂, Ti₃GeC₂, Ti₃SnC₂, Ti₃ZnC₂, Ti₄GaC₃, Ti₄GeC₃, and combinations thereof.

3. The multilayered capacitor of claim 1, wherein
the barium titanate-based compound includes at least one selected from the group consisting of BaₘTiO₃ (0.995≤m≤1.010), (Ba_{1-X}Caₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba_{1-X}Caₓ)ₘ(Ti_{1-y}Sn_{y})O₃ (0.995≤m≤1.010, 0≤x≤0.10, 0<y≤0.20), and combinations thereof.

4. The multilayered capacitor of claim 1, wherein
the dielectric layer further includes a subcomponent, and
the subcomponent includes at least one selected from the group consisting of dysprosium (Dy), vanadium (V), manganese (Mn), chromium (Cr), silicon (Si), aluminum (Al), magnesium (Mg), tin (Sn), antimony (Sb), and germanium. (Ge), gallium (Ga), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), indium (In), and combinations thereof.

5. The multilayered capacitor of claim 1, wherein
the dielectric layer further includes the co-material.

6. The multilayered capacitor of claim 1, wherein
the conductive metal includes at least one selected from the group consisting of Ni, Cu, Ag, Pd, Au, an alloy thereof, and combinations thereof.

7. The multilayered capacitor of claim 1, wherein
a cross-sectional area occupied by the co-material is about 0.1% to about 30% of a cross-sectional area of the internal electrode.

8. A multilayered capacitor, comprising
a capacitor body including a dielectric layer including a barium titanate-based compound as a main component; and an internal electrode including a conductive metal, and
an external electrode outside the capacitor body,
wherein at least one of the internal electrode, the dielectric layer, or an interface between the dielectric layer and the internal electrode, includes a co-material represented by Chemical Formula 1:
Mₙ₊₁AXₙ [Chemical Formula 1]
In Chemical Formula 1,
M includes at least one selected from the group consisting of Ti, Zr, Hf, Sc, Cr, V, Nb, Ta, Mo, Mn, and combinations thereof,
A includes at least one selected from the group consisting of a Group 11 element to a Group 16 element,
X includes C, N, or a combination thereof, and
n is an integer of 1 to 4.

9. The multilayered capacitor of claim 8, wherein
the co-material includes at least one selected from the group consisting of Ti₂AlC, V₂AlC, Cr₂AlC, Nb₂AlC, Ta₂AlC, Zr₂AlC, Ti₂AlN, Ti₃AlC₂, V₃AlC₂, Ta₃AlC₂, Zr₃AlC₂, Ti₄AlN₃, V₄AlC₃, Nb₄AlC₃, Ta₄AlC₃, (Mo,V)₄AlC₃, Mo₄VAlC₄, Ti₃SiC₂, Ti₄SiC₃, Ti₂CdC, Sc₂InC, Sc₂SnC, Ti₂GaC, Ti₂InC, Ti₂TlC, V₂GaC, Cr₂GaC, Ti₂GaN, Ti₂InN, V₂GaN, Cr₂GaN, Ti₂GeC, Ti₂SnC, Ti₂PbC, V₂GeC, Cr₂GeC, V₂PC, V₂AsC, Ti₂SC, Zr₂InC, Zr₂TlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂GaC, Hf₂SnC, Hf₂PbC, Hf₂SnN, Hf₂SC, Ti₂ZnC, Ti₂ZnN, V₂ZnC, Nb₂CuC, Mn₂GaC, Mo₂AuC, Ti₂AuN, Ti₃GaC₂, Ti₃InC₂, Ti₃GeC₂, Ti₃SnC₂, Ti₃ZnC₂, Ti₄GaC %, Ti₄GeC₃, and combinations thereof.

10. The multilayered capacitor of claim 8, wherein
the barium titanate-based compound includes at least one selected from the group consisting of BaₘTiO₃ (0.995≤m≤1.010), (Ba_{1-X}Caₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba_{1-X}Caₓ)ₘ(Ti_{1-y}Sn_{y})O₃ (0.995≤m≤1.010, 0≤x≤0.10, 0<y≤0.20), and combinations thereof.

11. The multilayered capacitor of claim 8, wherein
the dielectric layer includes a subcomponent, and
the subcomponent includes at least one selected from the group consisting of dysprosium (Dy), vanadium (V), manganese (Mn), chromium (Cr), silicon (Si), aluminum (Al), magnesium (Mg), tin (Sn), antimony (Sb), and germanium. (Ge), gallium (Ga), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), indium (In), and combinations thereof.

12. The multilayered capacitor of claim 8, wherein
the conductive metal includes at least one selected from the group consisting of Ni, Cu, Ag, Pd, Au, an alloy thereof, and combinations thereof.

13. The multilayered capacitor of claim 8, wherein
a cross-sectional area occupied by the co-material is about 0.1% to about 30% of a cross-sectional area of the internal electrode.

14. The multilayered capacitor of claim 1, wherein each of the internal electrode and the interface between the dielectric layer and the internal electrode includes the co-material represented by Chemical Formula 1.

15. The multilayered capacitor of claim 9, wherein each of the internal electrode, the dielectric layer, and an interface between the dielectric layer and the internal electrode includes the co-material represented by Chemical Formula 1.
